(19) United States
(12) Patent Application Publication
(10) Pub. No.: US 2010/0108304 A1
(43) Pub. Date: May 6, 2010

(54) HEAT EXCHANGER AND METHOD OF ASSEMBLING SAME

(76) Inventors: Jens Nies, Holzgerlingen (DE); Denis Bazika, Esslingen (DE); Rainer Kasinger, Haiterbach (DE); Andreas Stolz, Walddorfhaslach (DE); Thomas Feldhege, Leinfelden-Echterdingen (DE); Fritz Keller, Tuebingen (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/595,976

(22) PCT Filed: Jul. 10, 2008
(86) PCT No.: PCT/US08/08460

§ 371 Date: Jan. 13, 2010

(30) Foreign Application Priority Data
Jul. 10, 2007 (DE) 102007032015.0
Jul. 11, 2007 (DE) 102007032211.0
Apr. 30, 2008 (DE) 102008021544.9

(51) Int. Cl. F28F 9/02; B23P 15/26

(52) U.S. Cl. 165/173; 29/890.054

(57) ABSTRACT

The invention provides for a manufacturing process of a heat exchanger having a flat tube and fin core. The flat tube and fin core is formed in such a way that free flat tube ends are provided, wherein the flat tube and fin core is brazed in a brazing furnace, and wherein the flat tube ends are received in receptacle openings of a mounting plate and a header forming an enclosed space for receiving a bonding agent for coupling the flat tube ends to the header and mounting plate.

### CROSS-REFERENCE TO RELATED APPLICATIONS

Priority is hereby claimed to German Patent Application No. DE 10 2008 021 544.9 filed on Apr. 30, 2008, German Patent Application No. DE 10 2007 032 211.0 filed on Jul. 11, 2007, and German Patent Application No. DE 10 2007 032 015.0 filed on Jul. 10, 2007, the entire contents of which are incorporated herein by reference.

### BACKGROUND

The present invention relates to heat exchangers for vehicles and the manufacturing process therefor.

A conventional manufacturing method is shown in German Patent Application No. DE 10 2006 002 627.6. In this application, which has not yet been published, injection openings are provided for the bonding agent to be injected into the space around flat tube ends.

DE 38 09 944 C2 also discloses injection openings for applying the bonding agent in a heat exchanger. However, this document does not state whether a brazed flat tube and fin core is to be used. The manufacturing step of applying the bonding agent through injection openings is considered disadvantageous because it is not possible to monitor whether the bonding agent is introduced in a way which is compatible with quality requirements. In addition, a suitable backup solution is desirable.

WO 2007/009588 discloses a heat exchanger and a method of manufacturing the heat exchanger. The method disclosed does not provide for the flat tube ends to be bonded but instead provides for the flat tube ends to be plugged through openings in a plastic insertion plate and for the flat tube ends to be bent over onto the opening edges of the aforementioned insertion plate. This method is also considered undesirably complex due to the necessary shaping step.

### SUMMARY

The present invention provides a manufacturing process for a heat exchanger, in particular for motor vehicles, having a flat tube and fin core. The flat tube and fin core is formed in such a way that free flat tube ends are provided. The flat tube and fin core is brazed in a brazing furnace, and the flat tube ends are attached in receptacle openings of a header using a bonding agent or a sealing compound which is placed in a space around the flat tube ends.

One independent object of the present invention is to provide a cost-effective heat exchanger while improving the quality of the connections formed by a bonding material or agent.

For example, in some embodiments, the present invention provides a mounting plate with receptacle openings for receiving flat tube ends. A bonding agent can be applied to the mounting plate or to a header. The mounting plate and the header can form an enclosed space specifically for receiving the bonding agent. The enclosed space can provide a space at least partially defined by parts of the mounting plate and of the header. However, in alternate embodiments, the enclosed space can be connected to relatively small openings (e.g., venting openings or monitoring bores) for allowing the bonding agent to exit therethrough.

The step of applying the bonding agent can be carried out with a metered or predetermined quantity of bonding agent being applied to the mounted plate. The mounting plate is then connected to the header for pressing the bonding agent within the enclosed space. In some embodiments, the present invention provides that if the volume of the enclosed space is fixed, then the necessary quantity of bonding agent is also fixed. In some embodiments, the bonding agent partially fills the enclosed space. In other words, when the header is connected to the mounting plate, the amount of bonding agent is sufficient to leave a void within the enclosed space. In other embodiments, the bonding agent is sufficient to fill the enclosed space in an optimum way after the header is connected to the mounting plate. The bonding agent can be a commercially available bonding agent and can be injected into the enclosed space by, for example, injection needles.

The receptacle openings in the mounting plate and in the header are configured such that the openings can tightly receive the flat tube ends. In some embodiments, the mounting plate is first fitted onto the flat tube ends, wherein the tube ends can be simultaneously calibrated or newly aligned because the tube ends may have become distorted during the brazing process for forming the flat tube and fin core.

Because the receptacle openings of the header are intended to bear closely against the outer surfaces of the flat tubes, the enclosed space for receiving the bonding agent does not extend to the tube ends. Instead, the tube ends bear closely against the wall forming the receptacle openings of the header so that the bonding agent is restricted from flowing into the interior of the header. In addition, the enclosed space also extends only as far as the receptacle openings of the mounting plate so that the bonding agent is restricted from flowing therethrough. The bonding agent, which is preferably a pasty compound, can be satisfactorily applied on an arcuate or circumferentially shaped channel constructed between openings of the mounting plate. Other embodiments of the heat exchanger include a cup-shaped mounting plate.

The present invention also provides a mounting plate with receptacle openings to be connected to a header to form an enclosed space therebetween. Furthermore, a bonding agent can be injected into the enclosed space subsequent to the assembly of the header and mounting plate. In addition, venting of the enclosed space is permitted such that the enclosed space can be filled with the bonding agent to an optimum degree. To this end, at least one venting opening and at least one injection opening can be provided by the header and/or mounting plate. The size and number of the venting openings and injection openings can depend on the consistency of the bonding agent and manufacturing parameters of the headers and mounting plates. Therefore, the size and number of such openings can be selected in such a way that the openings provide optimum functionality during assembly of the heat exchanger.

Alternatively or in addition, the mounting plate and the header of the heat exchanger can be connected as a single unit with a clamping device. In some such embodiments, the heat exchanger remains under tension until the bonding agent is injected. However, it is also possible for the mounting plate to be held together with the header by elastic clamps or the like, where the clamps are located or integrally formed on one of the header and the mounting plate after applying the bonding agent.

In some embodiments, the invention provides a method of manufacturing a heat exchanger for motor vehicle applications. The method can include the acts of forming a flat tube and fin core with tube ends extending from the core, mounting a mounting plate onto the flat tube and fin core, connecting a header to the mounting plate and flat tube and fin core, such that a substantially enclosed space is defined between the header and mounting plate around a portion of at least one of the tube ends, and applying a bonding agent to the enclosed space for connecting the header, mounting plate and tube ends.

In other embodiments, the invention provides a heat exchanger for motor vehicle applications. The heat exchanger includes a flat tube and fin core having a number of tube ends extending from the core, a mounting plate connected to the flat tube and fin core adjacent to the tube ends, and a header connected to the mounting plate and adjacent to the tube ends, the mounting plate and the header forming an enclosed space around a portion of at least one of the tube ends for receiving a bonding agent connecting the header, mounting plate and tube ends.

Other aspects of the invention will become apparent by consideration of the detailed description and accompanying drawings.

### BRIEF DESCRIPTION OF THE DRAWINGS

FIG. 1 illustrates a heat exchanger according to a first embodiment of the present invention.

FIG. 2 is a partial cross section of the heat exchanger of FIG. 1 specifically illustrating a header and flat tube ends of the heat exchanger.

FIG. 3 is a cross section taken along A-A.

FIG. 4 is a partial cross section of the heat exchanger of FIG. 1 specifically illustrating an intermediate stage of a manufacturing process for forming the heat exchanger.

FIG. 5 is a detailed view of a portion of a mounting plate of the heat exchanger of FIG. 1.

FIG. 6 is a partial cross section of a heat exchanger according to a second embodiment of the present invention particularly illustrating a partial longitudinal section of the heat exchanger.

FIG. 7 is a detailed view of a portion of a mounting plate of the heat exchanger of FIG. 6.

FIG. 8 illustrates a first intermediate stage of a manufacturing process for forming a heat exchanger according to the present invention.

FIG. 9 illustrates a second intermediate stage of the manufacturing process of the present invention.

FIG. 10 illustrates a third intermediate stage of the manufacturing process of the present invention.

FIG. 11 is a cross section of a flat tube of a heat exchanger according to the present invention.

FIG. 12 is a partial cross section of a heat exchanger according to a third embodiment of the present invention particularly illustrating a partial longitudinal section of the heat exchanger.

FIG. 13 illustrates a detailed view of a portion of a mounting plate of the heat exchanger in FIG. 12.

FIG. 14 illustrates the mounting plate of FIG. 13 with a boding agent.

FIG. 15 illustrates an alternate embodiment of a mounting plate of a heat exchanger according to the present invention.

FIG. 16 is a detailed view of a portion of the mounting plate of FIG. 15.

FIG. 17 illustrates a heat exchanger according to a fourth embodiment of the present invention.

FIG. 18 is an exploded view of a portion of the heat exchanger of FIG. 17.

FIG. 19 is a partial cross section of the heat exchanger of FIG. 17 particularly illustrating a longitudinal cross section of the heat exchanger.

FIG. 20 is another partial cross section of the heat exchanger of FIG. 17 particularly illustrating one alternate embodiment of the heat exchanger.

FIG. 21 is another cross section of the heat exchanger in FIG. 17 particularly illustrating another alternate embodiment of the heat exchanger.

### DETAILED DESCRIPTION

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

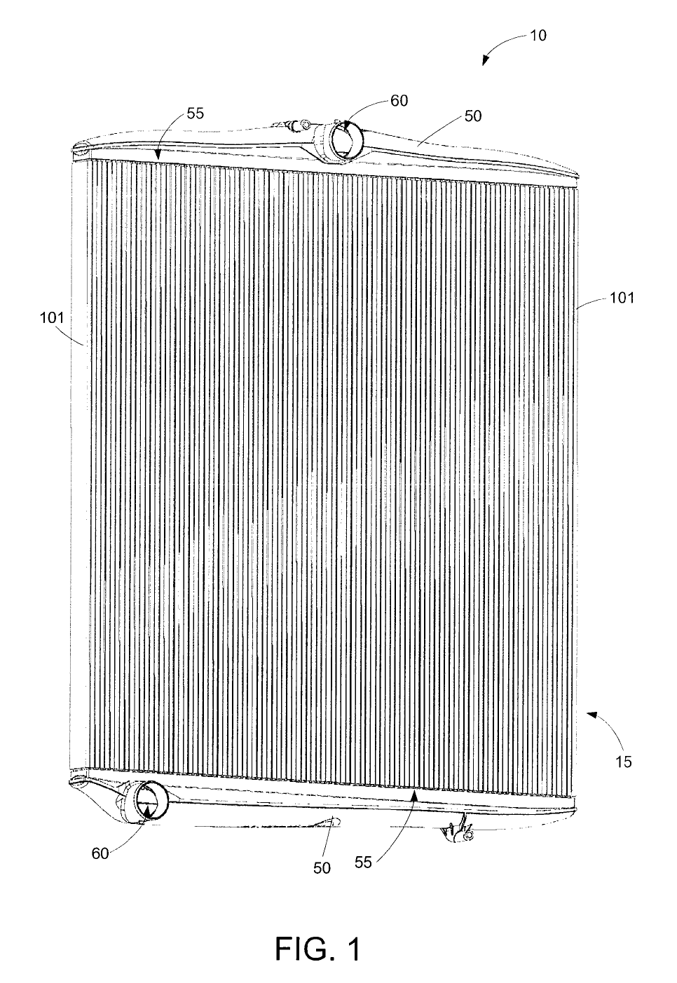

FIG. 1 illustrates a heat exchanger 10 according to some embodiments of the present invention. The heat exchanger 10 is a coolant cooler particularly suitable for motor vehicle applications. However, the heat exchanger 10 can have applications other than those described in this application.

The method of forming a flat tube and fin core 15 of the heat exchanger 10 includes alternatively pre-treating flat tubes 20 and fins 25 and brazing the flat tubes 20 and fins 25 (by a brazing process in a furnace, for example). The flat tubes 20 and the fins 25 can be manufactured from braze-coated, relatively thin sheet aluminum. For example, the thickness of the aluminum sheet can be between about 0.03 mm and about 0.15 mm. In other embodiments, the heat exchanger 10 can include tubes 20 and/or fins 25 of different materials and having a different range of sheet thickness.

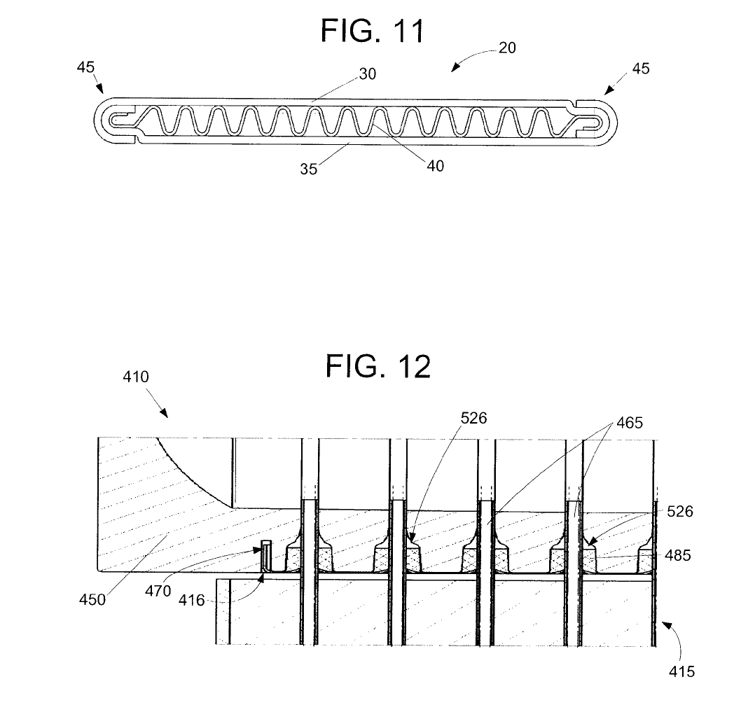

FIG. 11 illustrates a cross section of one exemplary flat tube 20 of the heat exchanger 10. However, the following description of the flat tube 20 is also applicable to alternate heat exchangers described in this application. As illustrated in FIG. 11, the flat tube 20 includes first, second and third sheet metal strips 30, 35 and 40. More specifically, first and second sheet metal strips 30 and 35 are shaped to form the outer wall of the flat tube 20 and the third sheet metal strip 40 is shaped to form a corrugated internal insert of the flat tube 20. The insert 40 is manufactured from a relatively thinner sheet metal strip in comparison to the first and second sheet metal strips 30 and 35, which form the walls of the flat tube 20. Narrow sides 45 of the flat tube 20 are reinforced by overlapping the longitudinal edges of the first and second sheet metal strips 30 and 35 and additionally by folding the longitudinal edges of the internal insert 40 to nest the folded longitudinal edges inside of the overlapped longitudinal edges of the first and second sheet metal strips 30 and 35. It is to be understood that the flat tube 20 illustrated herein is only an exemplary embodiment. Further, other embodiments of the flat tube 20 fall within the scope of the present invention.

With reference to FIG. 1, the heat exchanger 10 further includes headers 50 and mounting plates 55 cooperating to at least partially support the flat tube and fin core 15. Each header 50 is sealingly connected to a corresponding mounting plate 55. The headers 50 include inlet/outlet apertures 60 for directing the flow of a suitable fluid through the heat exchanger 10. In the illustrated embodiment, the headers 50 and mounting plates 55 are formed of a plastic material. Because both headers 50 and mounting plates 55 are manufactured from plastic material, the weight of the heat exchanger 10 is relatively low in comparison to heat exchangers having metal headers. This allows the heat exchanger 10 to meet or exceed the latest weight requirements in the automobile industry. Furthermore, the heat exchanger 10 can also or alternatively meet or exceed current industry requirements in terms of the heat exchanging properties. It is to be understood that the header 50 can be embodied in one or more parts formed of a plastic material, which can then be fused. Accordingly, the term “header” encompasses a header part (e.g., header 50) including one or more individual parts.

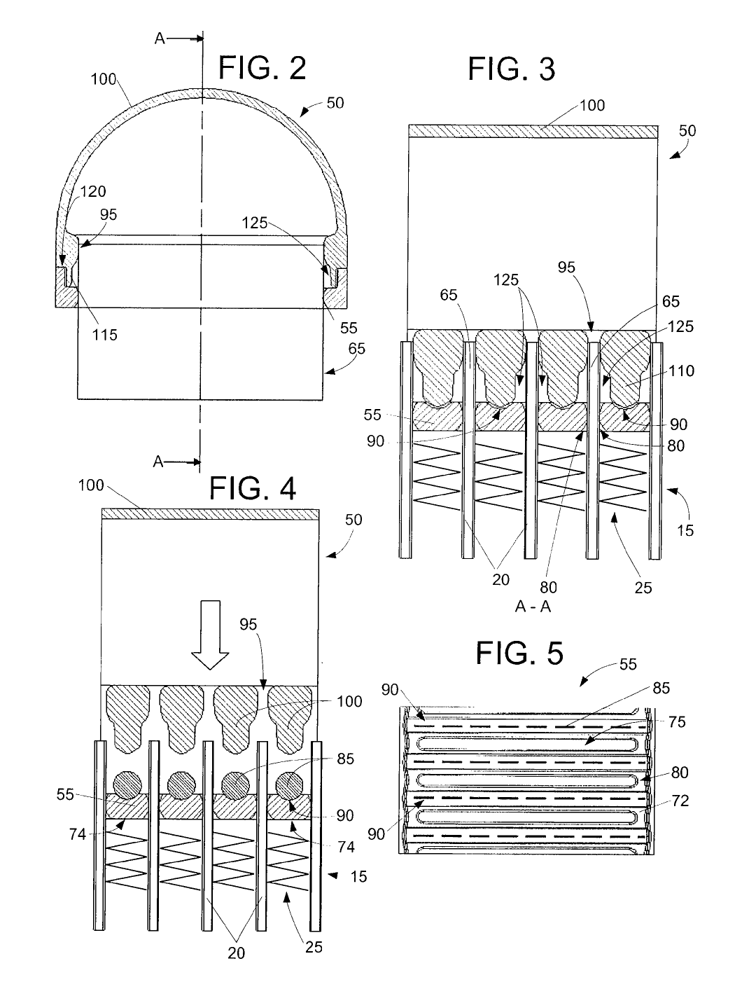

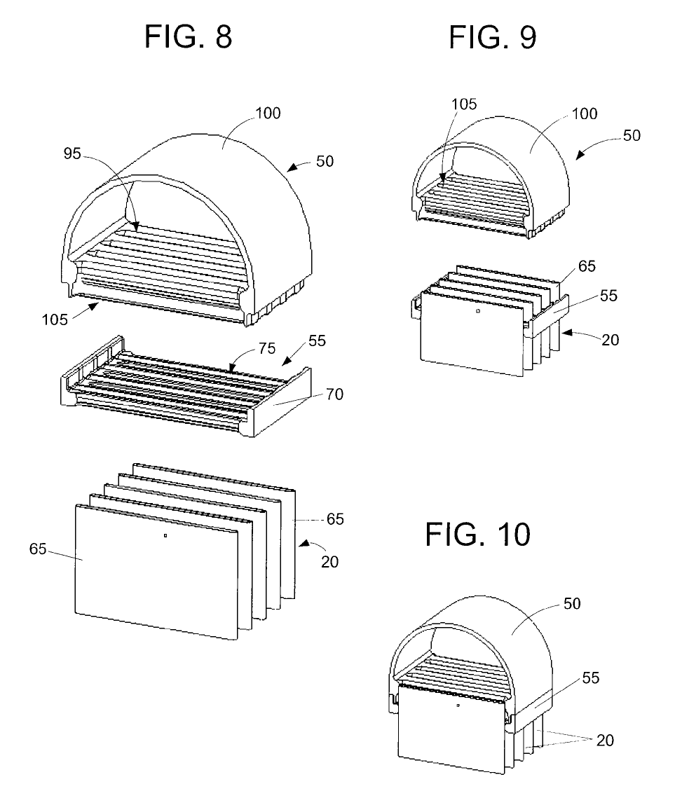

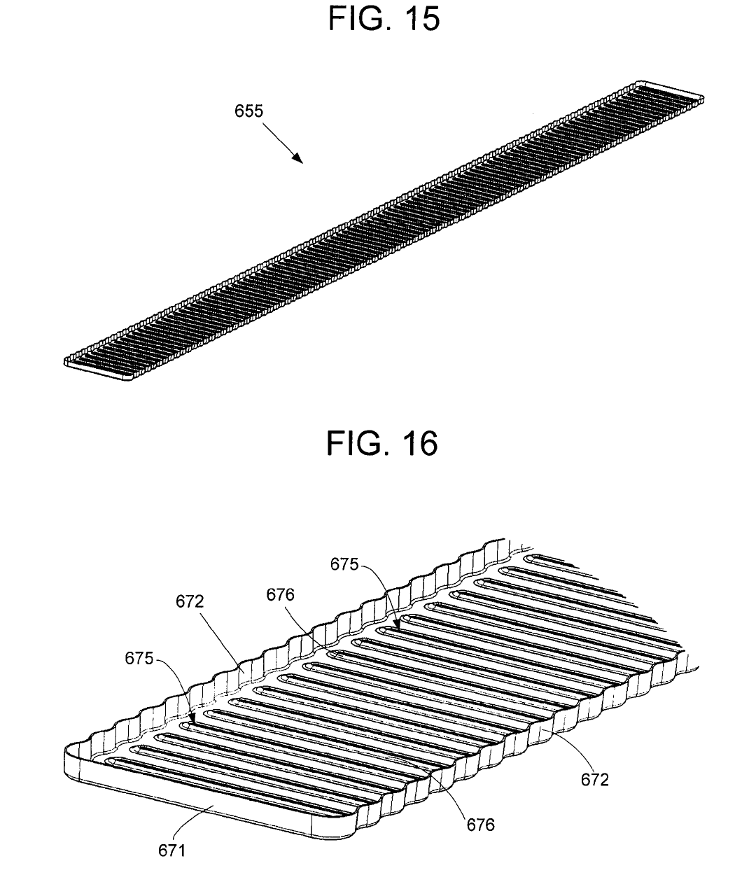

FIGS. 8-10 illustrate intermediate stages of the manufacturing process of the heat exchanger 10. However, the intermediate stages and/or steps related to the process described in relation to FIGS. 8-10 are also applicable to alternate heat exchangers described in this application. With reference to FIGS. 2, 3 and 8, each of the mounting plates 55 includes a peripheral side wall 70, an inner surface 72 facing the header 50, an outer surface 74 facing the flat tube and fin core 15 and a number of elongated openings 75. Each of the elongated openings 75 is operable to receive one corresponding tube end 65 of the flat tube and fin core 15. An alternate mounting plate 655 is illustrated FIGS. 15 and 16. Similar to the mounting plate 55, the mounting plate 655 includes a peripheral side wall 670, an inner surface 672, an outer surface 674 and a number of elongated openings 675. However, the side wall 670 includes two flat sides 671 formed at the longitudinal ends of the mounting plate 655 and two corrugated sides 672 formed along the length of the mounting plate 655. In addition, the inner surface 672 is substantially flat and the openings 675 are defined by flange-like or bent edges 676.

FIGS. 2 and 3 illustrate a stage of the manufacturing process of the heat exchanger 10 in which the mounting plate 55 has been fitted onto the flat tube ends 65. During the brazing process for forming the flat tube and fin core 15, the flat tubes 20 and/or fins 25 may become deformed and fitting the mounting plate 55 onto the tube ends 65 can realign the tube ends 65. As illustrated in FIGS. 2-5, the openings 75 include chamfered edges 80 to ease the insertion of the tube ends 65 through the openings 75. In the illustrated embodiment, the mounting plates 55 are connected to the flat tube and fin core 15 such that each mounting plate 55 is fitted tightly against the fins 25 of the flat tube and fin core 15.

A bonding agent 85, schematically illustrated with a circular cross section in FIG. 4 or with dashed lines in FIG. 5, is applied to the inner surface 72 of the mounting plate 55. The bonding agent 85 may be silicone-based and may be a commercially available product. However, other embodiments of the heat exchanger 10 can include other types of bonding agents. The bonding agent 85 can be applied to the mounting plate 55 prior to connecting the mounting plate 55 to the flat tube and fin core 15 (FIG. 8) or subsequent thereto (FIG. 9). In the illustrated embodiment, the inner surface 72 defines a number of elongated channels 90. Each channel 90 is further defined between two elongated openings 75 and extends along the width of the mounting plate 55. Accordingly, the bonding agent 85 is placed on the channels 90 for ease of the forming process of the heat exchanger 10. In the illustrated embodiment, the channels 90 do not extend around the narrow areas of the inner surface 72 defined mainly between the ends of the openings 75 and the peripheral wall 70 of the mounting plate 55.

Subsequent to applying the bonding agent 85, the header 50 is fitted onto the corresponding mounting plate 55, as illustrated in FIGS. 2, 3 and 10. The header 50 includes an outer wall 100 and an inner structure 105 joining the two ends of the outer wall 100. In the illustrated embodiment, the inner structure 105 is integrally formed with the outer wall 100 and defines a number of receptacle openings 95 for receiving the tube ends 65 of the flat tube and fin core 15, a number of elongated projections 110 each between two openings 95, and a projection 115 with a shoulder 120 for engaging the peripheral side wall 70 of the corresponding mounting plate 55.

Upon engagement of the header 50 with the corresponding mounting plate 55 and tube ends 65 (FIGS. 2, 3 and 10), the projections 110 engage corresponding channels 90, distributing the bonding agent 85 thereon. Concurrently, the tube ends 65 are received in corresponding receptacle openings 95 of the header 50. In the illustrated embodiment, the tube ends 65 do not project into the interior (also known and the tank portion) of the header 50. For this reason only a relatively small pressure loss occurs during operation of the heat exchanger 10. Engagement of the headers 50 with corresponding mounting plates 55 and tube ends 65 forms a number of enclosed spaces 125 therebetween. Particularly, each enclosed space 125 is defined by the inner surface of the projections 110 of the header 50, the inner surface 72 of the mounting plate 55 and a portion of the outer surface of the tube ends 65.

In some embodiments, the quantity of the bonding agent 85 is calculated such that the bonding agent 85 redistributed by engagement of the projections 110 with corresponding channels 90 fills a portion of each of the enclosed spaces 125, thus leaving a void within each of the enclosed spaces 125. In another embodiment, the quantity of bonding agent 85 is precisely calculated and is perhaps slightly more than the volume of the enclosed spaces 125. Accordingly, the bonding agent 85 redistributed by engagement of the projections 110 with the corresponding channels 90 entirely fills the enclosed spaces 125. FIGS. 2 and 3 illustrate the enclosed space 125 in a closed state. However, other embodiments of the heat exchanger 10 can include openings defined by the headers 50 and/or mounting plates 55 to allow bonding agent 85 therethrough to relieve pressure.

In the illustrated embodiment of FIGS. 2 and 3, the tube ends 65 are tightly received within the openings 95. Therefore, the tube ends 65 are not part or do not define the enclosed spaces 125. Further, the bonding agent 85 is prevented from passing through the engagement between the tube ends 65 and the walls defining the openings 95 and into the interior of the header 50. Similarly, the bonding agent 85 is prevented from passing through the engagement between tube ends 65 and inner walls of the openings 75 of the mounting plates 55. As illustrated in FIG. 2, the enclosed space 125 for receiving the bonding agent 85 extends around the narrow sides 45 of the flat tubes 20. In the illustrated embodiment, there is no provision for a bonding connection between the longitudinal edges of the header 50 and the mounting plate 55. On the contrary, the projection 115 cooperates with the inner edge of the peripheral side wall 70 of the mounting plate 55 for preventing bonding agent 85 from flowing therebetween. Further functions of the projection 115 are to define or limit the depth at which the header 50 is connected to the mounting plate 55 (FIG. 2), and also to ensure better overall stability of the header 50 and mounting plate 55.

With reference to FIG. 1, the heat exchanger 10 includes side parts 101 for, among other things, relieving loading of the bonded connections of the tube ends 65. The side parts 101 are two sheet metal strips arranged to the left and right sides of the flat tube and fin core 15 and connected to the headers 50 that are also on opposite sides of the flat tube and fin core 15. Generally, the side parts 101 are fitted on or connected to the flat tube and fin core 15 before brazing the flat tubes 20 and fins 25 together. In the illustrated embodiment, the side parts 101 are approximately 1.0 mm thick and therefore thinner than other side parts used in conventional heat exchangers. It is to be understood that the side parts 101 are optional and that the bonded connections between the headers 50, 250, 450, corresponding mounting plates 55 and tube ends 65 are sufficiently durable to support the operation of the heat exchanger 10. It is to be understood that the principles and features described above with respect to the heat exchanger 10 are also applicable to other heat exchangers described in this application.

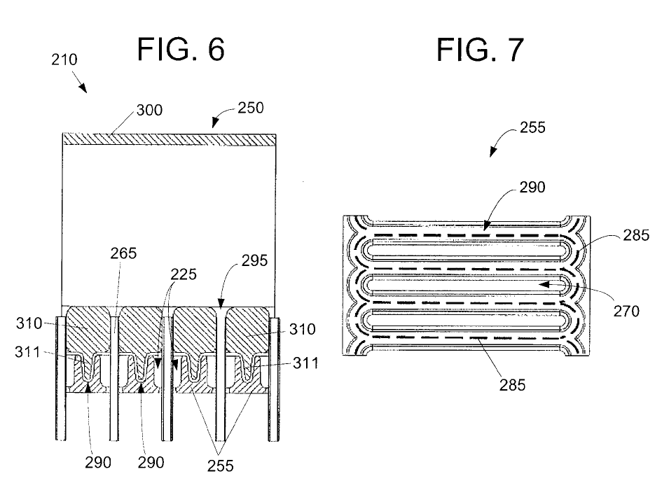

FIGS. 6 and 7 illustrate a heat exchanger 210 according to an alternate embodiment including, among other things, a header 250 and a mounting plate 255. The heat exchanger 210 employs much of the same structure and has many of the same properties as other heat exchangers described in this application. Accordingly, the following description focuses primarily upon the structure and features that are different than the other heat exchangers described in this application. Reference should be made to the description in connection with the other heat exchangers described in this application for additional information regarding the structure and features, and possible alternatives to the structure and features of the heat exchanger 210 illustrated in FIGS. 6 and 7 and described below. Structure and features of the heat exchanger 210 shown in FIGS. 6 and 7 that correspond to structure and features of the other heat exchangers described in this application are designated hereinafter in respective two and three hundred series of reference numbers.

As illustrated in FIGS. 6 and 7, channel 290 is made significantly deeper than the previously described channel 90 and also extends around elongated openings 275 of the mounting plate 255. Accordingly, upon engagement of the header 250 with mounting plate 255 and end tubes 265, the channel 290 extends around the narrow side 245 of the flat tubes 220. With particular reference to FIG. 6, the channel 290 receives an elongated portion 311 of the projection 310 of the header 250. The projection 310 with elongated portion 311 is adapted or formed to conform to the deeper channel 290. Accordingly, each enclosed space 325 is substantially defined by the portion of the inner surface 272 forming the channel outer wall of the mounting plate 255, and not by the border of the receptacle openings 295 of the header 250, as in the embodiment of the heat exchanger 10 described above with respect to FIGS. 1-5.

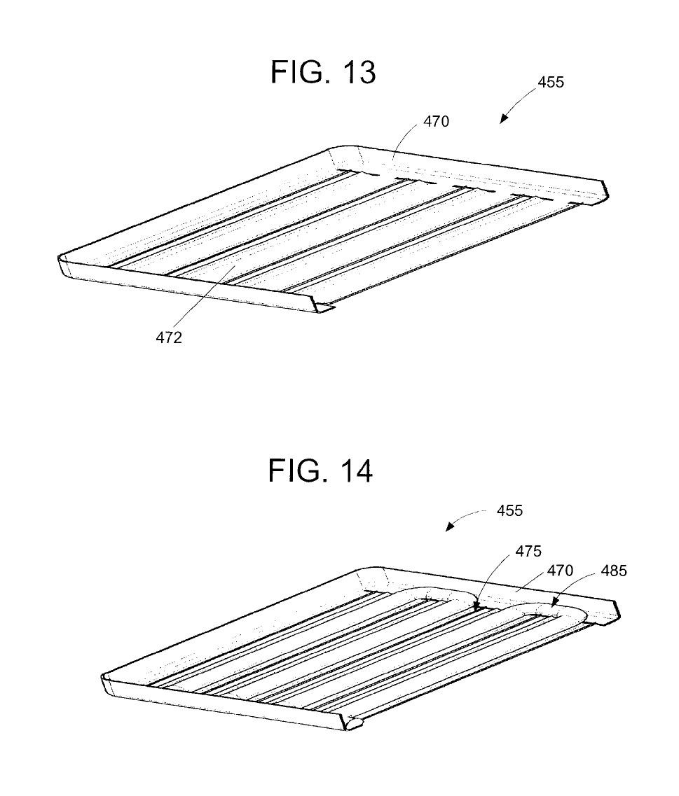

FIGS. 12-14 illustrate a heat exchanger 410 according to an alternate embodiment including, among other things, a header 450 and a mounting plate 455. The heat exchanger 410 employs much of the same structure and has many of the same properties as other heat exchangers described in this application. Accordingly, the following description focuses primarily upon the structure and features that are different than the other heat exchangers described in this application. Reference should be made to the description in connection with the other heat exchangers described in this application for additional information regarding the structure and features, and possible alternatives to the structure and features of the heat exchanger 410 illustrated in FIGS. 12-14 and described below. Structure and features of the heat exchanger 410 shown in FIGS. 12-14 that correspond to structure and features of the other heat exchangers described in this application are designated hereinafter in respective four and five hundred series of reference numbers.

As illustrated in FIGS. 12-14, the embodiment of the mounting plate 455 differs from the previously described mounting plates 55, 255 in that the mounting plate 455 has a cup-shaped design with a predominantly circumferential peripheral side wall 70. It is to be noted that FIGS. 12-14 only illustrate one end of the mounting plate 455. However, the mounting plate 455 extends over approximately the entire length of the flat tube and fin core 415. In the illustrated embodiment, the mounting plate 455 is formed of a plastic material with a thickness of about 1 mm or less. In the illustrated embodiment, the mounting plate 455 does not provide alignment for the tube ends 465, as described above with respect to mounting plates 55, 255. Another difference with the previously described mounting plates 55, 255 is that no channel is formed. The mounting plate 455 is of a substantially flat design, apart from the circumferential, upright side wall 475.

Further, the enclosed space 525 formed as a result of the engagement between the header 450 and corresponding mounting plate 455 and end tubes 465 is not entirely filled with bonding agent 485. With particular reference to FIG. 12, a relatively small upper portion of the space 525 remains substantially free of bonding agent, forming a void 526 within the space 525. Forming such a void 526 helps avoid stresses and/or strains in or caused by the bonding agent 525. In order to securely position the mounting plate 455, the latter is let into, for example, groove-like depressions 416 in the header 450. The inventors have found that the quality of the bonded connection between the header 450 and the mounting plate 455 improves significantly if there is no flux in the bonding area.

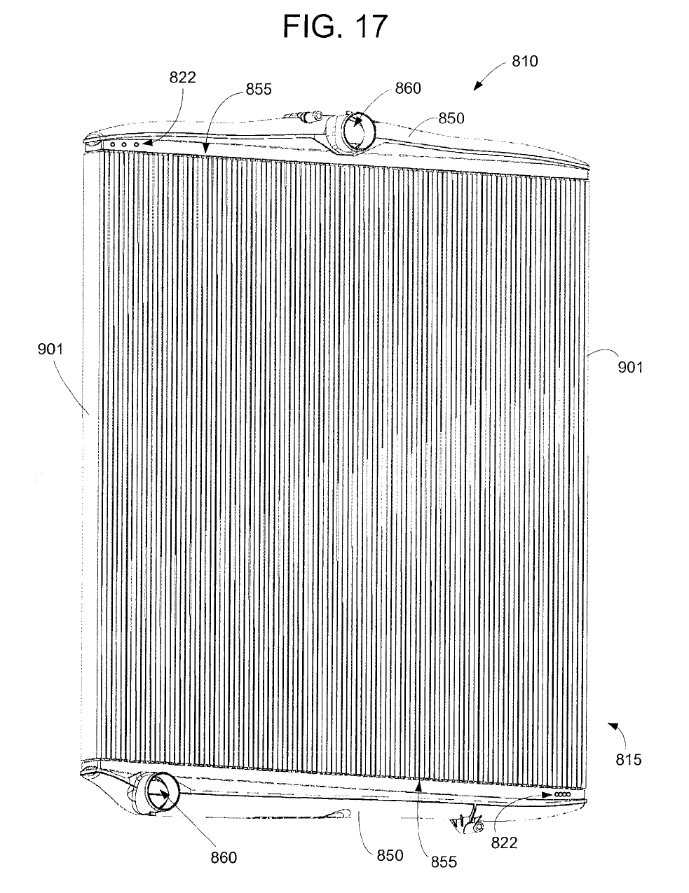

FIGS. 17-21 illustrate a heat exchanger 810 according to another embodiment of the present invention. The heat exchanger 810 employs much of the same structure and has many of the same properties as other the heat exchangers described in this application. Accordingly, the following description focuses primarily upon the structure and features that are different than the other heat exchangers described in this application. Reference should be made to the description of the other heat exchangers described in this application for additional information regarding the structure and features, and possible alternatives to the structure and features of the heat exchanger 810 illustrated in FIGS. 17-21 and described below. Structure and features of the heat exchanger 810 shown in FIGS. 17-21 that correspond to structure and features of the other heat exchangers described in this application are designated hereinafter in respective eight and nine hundred series of reference numbers.

The heat exchanger 810 is a coolant cooler particularly suitable for motor vehicle applications. However, the heat exchanger 810 can have applications other than the ones described in this application.

The method of forming a flat tube and fin core 815 of the heat exchanger 810 includes alternatively pre-treating flat tubes 820 and fins 825 and brazing the flat tubes 820 and fins 825 (by a brazing process in a furnace, for example). The flat tubes 820 and the fins 825 are manufactured from braze-coated, relatively thin sheet aluminum. For example, the sheet metal thickness of the aluminum sheet can range between about 0.03 mm and about 0.15 mm. In other embodiments, the heat exchanger 810 can include tubes 820 and/or fins 825 of different materials and having a different sheet thickness.

With reference to FIG. 17, the heat exchanger 810 further includes headers 850 and mounting plates 855 cooperating to at least partially support the flat tube and fin core 815. Each header 850 is sealingly connected to a mounting plate 855. The headers 850 include inlet/outlet apertures 860 for directing the flow of a suitable fluid through the heat exchanger 810. In the illustrated embodiment, the headers 850 and mounting plates 855 are formed of a plastic material. Because both headers 850 and mounting plates 855 are manufactured from plastic material, the weight of the heat exchanger 810 is relatively low in comparison to conventional heat exchangers with metal headers. This allows the heat exchanger 810 to meet or exceed the latest weight requirements in the automobile industry. Furthermore, the heat exchanger 810 also meets or exceeds current industry requirements in terms of the heat exchanging properties. It is to be understood that the header 850 can be embodied in one or more parts formed of a plastic material, which can then be fused. Accordingly, the term “header” encompasses a header part (e.g., header 850) including one or more parts.

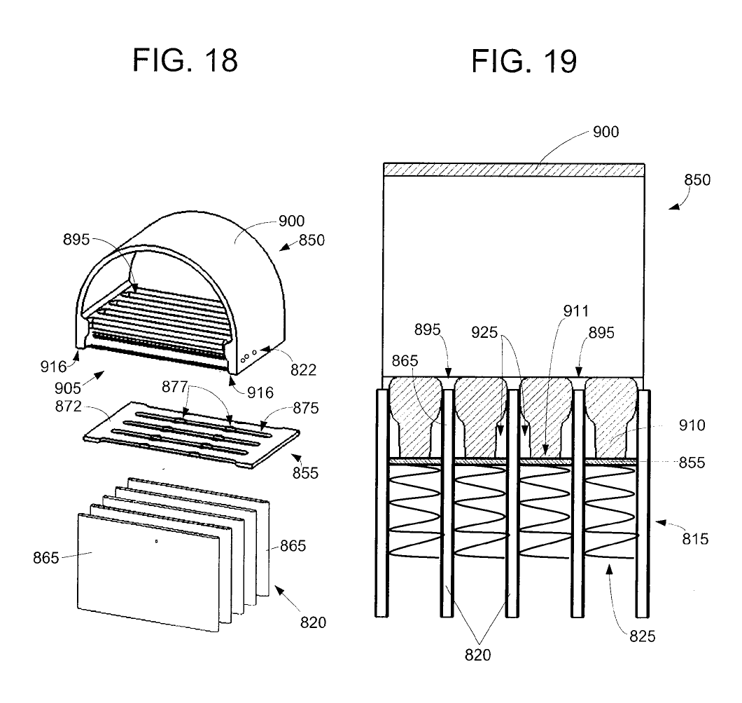

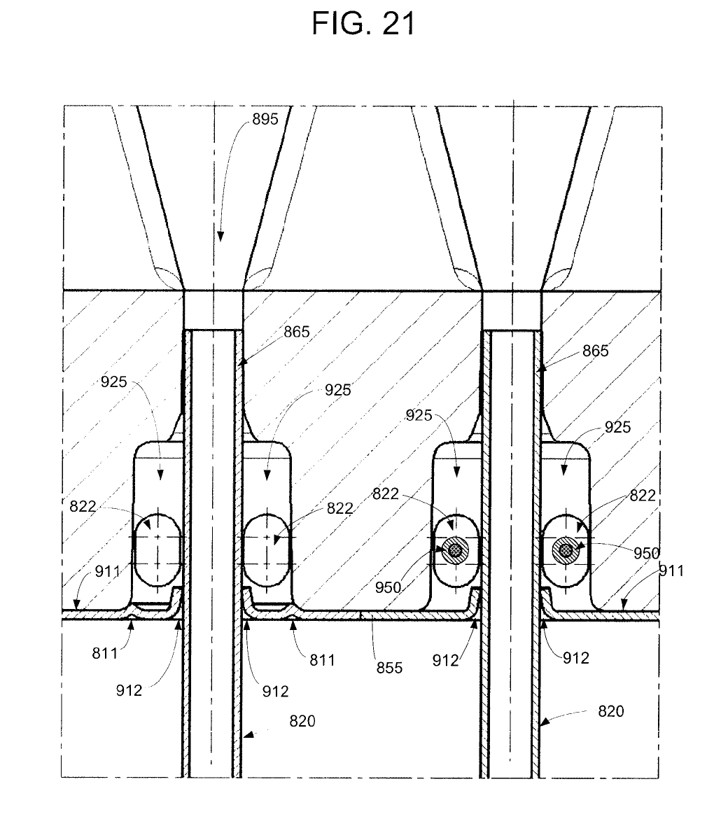

With reference to FIGS. 18-21, each of the mounting plates 855 includes an inner surface 872 facing the header 850, an outer surface 874 facing the flat tube and fin core 815, a number of elongated openings 875 and two venting openings 877. The venting openings 877 are defined by two grooves formed at opposite edges of the openings 875. Each of the elongated openings 875 is operable to receive one corresponding tube end 865 of the flat tube and fin core 815. In the illustrated embodiment, the mounting plate 855 is a plate having a thickness of about or significantly less than 1.0 mm. FIG. 21 illustrates two alternate aspects of the mounting plate 855 and particularly of the receptacle openings 875. In the some embodiments, the mounting plate 855 includes beads 811 formed around the openings 875. The beads 811 correspond to the edges of the enclosed space 925. More specifically, the beads 811 substantially match or align with the inner surface of an elongated projection 910 to define the enclosed space 920. In other embodiments, the openings 875 are defined by a flange-like border 912 for providing a relatively tight closure around each tube end 865. In both aspects of the receptacle openings 875, the bent or flange-like borders 912 allow simplified insertion of the tube ends 865 through the openings 875 of the mounting plate 855.

FIGS. 19-21 illustrate a portion of the manufacturing process of the heat exchanger 810 wherein the mounting plate 855 has been fitted onto the flat tube ends 865. During the brazing process for forming the flat tube and fin core 815, the flat tubes 820 and/or fins 825 may become deformed and fitting the mounting plate 855 onto the tube ends 865 can realign the tube ends 865. The mounting plates 855 are connected to the flat tube and fin core 815 such that each mounting plate 855 is fitted tightly against the fins 825 of the flat tube and fin core 815.

Subsequent to fitting the mounting plate 855 onto the tube ends 865 of the flat tube and fin core 815, the header 850 is fitted onto the mounting plate 855. The header 50 includes an outer wall 900 and an inner structure 905 joining the two ends of the outer wall 900. In the illustrated embodiment, the inner structure 905 is integrally formed with the outer wall 900 and defines a number of receptacle openings 895 for receiving the tube ends 865 of the flat tube and fin core 815, a number of elongated projections 910 each including a flat bottom 911 and formed between two openings 995, and a contact portion or surface 916 for engaging the inner surface 872 of the corresponding mounting plate 855.

Upon engagement of the header 850 with the corresponding mounting plate 855 and tube ends 865 (FIGS. 19-21), the flat bottom 911 of the projections 910 engage the inner surface 872 of the mounting plate 855 as the tube ends 865 are received in the receptacle openings 895 of the header 850. In the illustrated embodiment, the tube ends 865 do not project into the interior of the header 850. For this reason, only a relatively small pressure loss occurs during operation of the heat exchanger 810. Engagement of the headers 850 with corresponding mounting plates 855 and tube ends 865 forms a number of enclosed spaces 925 therebetween. Particularly, each enclosed space 925 is defined by the inner surface of the projections 910, the inner surface 972 of the mounting plate 955 and a portion of the outer surface of the tube ends 965.

As illustrated in FIGS. 19-21, the tube ends 865 are tightly received within the openings 895. Therefore, the tube ends 865 are not part or do not define the enclosed spaces 925. Further, a bonding agent 885 is prevented from passing through the engagement between the tube ends 865 and the openings 895 and into the interior of the header 850. Similarly, the bonding agent 885 is prevented from passing through the engagement between tube ends 865 and inner walls of the openings 875 of the mounting plates 855, except at the location of the venting openings 877. In other embodiments, venting openings (similar to openings 877) can be formed at other locations of the mounting plate 855 or on the headers 850.

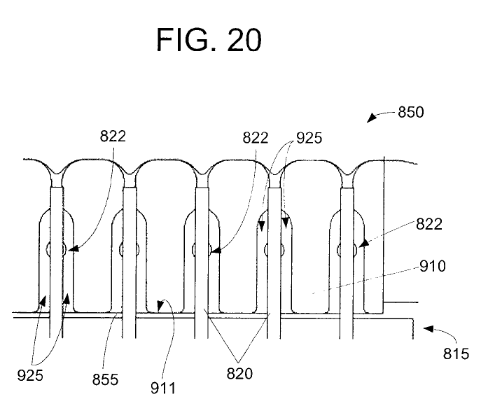

Subsequent to forming the heat exchanger 810, as illustrated in FIG. 17, a bonding agent is injected into the enclosed spaces 925 through injection openings 822. In the illustrated construction, the injection openings 822 are formed on the side of the header 850 and in substantial alignment with the peripheral edge of the header 850 as schematically illustrated in FIGS. 17 and 18. It is to be noted that FIGS. 17 and 18 only show a few injection openings 822 for exemplary purposes. However, the injection openings 822 can extend throughout the entire length of the header 850. In the embodiment illustrated in FIG. 20, one injection opening 822 is formed in alignment with each of the enclosed spaces 925 formed as a result of connecting the header 850, mounting plate 855 and tube ends 865. In the embodiment illustrated in FIG. 21, two injection openings 822 are formed in alignment with each of the enclosed spaces 925. Other embodiments can include a different number of injection openings 822 formed for each of the enclosed spaces 925.

As illustrated in FIG. 21, injection needles 950 are inserted into the enclosed space 925 in the direction of the width of the header 850 and through the injection openings 822. The injection needles 950 are inserted substantially the full length (along the width of the header 850) of the enclosed space 925. Then the bonding agent 885 is inserted into the enclosed spaces 925 through the injection needles 950 as the needles 950 are concurrently retracted outwardly through the injection openings 822 and out of the enclosed space 925. This process ensures that the enclosed spaces 925 are filled with the bonding agent 885 to an optimum degree.

In some embodiments, the quantity of the bonding agent 885 is calculated such that the amount of bonding agent 885 injected into the enclosed space 925 fills a portion of the enclosed space 925, thus leaving a void within each of the enclosed spaces 925. In other embodiments, the quantity of bonding agent 885 is precisely calculated and is perhaps slightly more than the volume of the enclosed spaces 925. Accordingly, the bonding agent 885 injected into the enclosed spaces 925 entirely fills the enclosed spaces 925.

With reference to FIG. 17, the heat exchanger 810 includes side parts 901 for the purpose of relieving loading of the bonded connections of the tube ends 865. The side parts 901 are two sheet metal strips arranged to the left and right sides of the flat tube and fin core 815 and connected to the headers 850 that are also on opposite sides of the flat tube and fin core 815. Generally, the side parts 901 are fitted on or connected to the flat tube and fin core 815 before brazing the flat tubes 820 and fins 825 together. In the illustrated embodiment, the side parts 901 are about 1.0 mm thick and are therefore thinner than other side parts used in conventional heat exchangers. It is to be understood that the side parts 901 are optional features to the heat exchanger 810 and that the bonded connections between the headers 850, corresponding mounting plates 855 and tube ends 865 are sufficiently durable to support the operation of the heat exchanger 810.

Various features and advantages of the invention are set forth in the following claims.

What is claimed is:

1. A method of manufacturing a heat exchanger, the method comprising:
forming a flat tube and fin core with tube ends extending from the core;
mounting a mounting plate onto the flat tube and fin core;
coupling a header to the mounting plate and flat tube and fin core, such that a substantially enclosed space is defined between the header and mounting plate around a portion of at least one of the tube ends; and
applying a bonding agent to the enclosed space to couple the header, mounting plate and tube ends.

2. The method of claim 1, wherein forming the flat tube and fin core includes brazing a number of flat tubes to a number of fins in a soldering furnace.

3. The method of claim 1, wherein mounting the mounting plate onto the flat tube and fin core includes tightly fitting the tube ends within elongated openings of the mounting plate until the mounting plate contacts at least one fin of the flat tube and fin core.

4. The method of claim 1, further comprising aligning at least two tubes of the flat tube and fin core by mounting the mounting plate onto the flat tube and fin core.

5. The method of claim 1, wherein coupling the header to the mounting plate and flat tube and fin core includes tightly fitting the tube ends within openings of the header such that the end portions of each of the tube ends do not extend within the tank portion of the header.

6. The method of claim 1, wherein applying the bonding agent includes applying the bonding agent to a surface of the mounting plate;
pressing the bonding agent with a portion of the header; and
distributing the bonding agent to the enclosed space around each of the tube ends.

7. The method of claim 6, wherein applying the bonding agent to the mounting plate includes applying the bonding agent before mounting the mounting plate to the flat tube and fin core.

8. The method of claim 6, wherein applying the bonding agent to the mounting plate includes applying the bonding agent after mounting the mounting plate to the flat tube and fin core.

9. The method of claim 1, wherein applying the bonding agent includes injecting the bonding agent through injection openings in the header in communication with the enclosed space around each of the tube ends.

10. The method of claim 1, wherein applying the bonding agent includes the substantially filling the enclosed space with bonding agent.

11. The method of claim 1, wherein applying the bonding agent includes partially filling the enclosed space with bonding agent to form a void within the enclosed space.

12. The method of claim 1, wherein applying a bonding agent to the enclosed space comprises applying a bonding agent to a plastic surface of at least one of the header and mounting plate.

13. The method of claim 1, further comprising brazing the flat tube and fin core before mounting the mounting plate onto the flat tube and fin core.

14. A heat exchanger comprising:
a flat tube and fin core having a number of tube ends extending from the core;
a mounting plate connected to the flat tube and fin core adjacent the tube ends; and
a header connected to the mounting plate adjacent the tube ends, the mounting plate and the header forming an enclosed space around at least one of the tube ends for receiving a bonding agent coupling the header, mounting plate and tube ends.

15. The heat exchanger of claim 14, the flat tube and fin core includes a number of tubes and fins brazed together in a soldering furnace.

16. The heat exchanger of claim 14, wherein the mounting plate includes receptacle openings shaped to receive corresponding tube ends until the plate contacts fins of the flat tube and fin core.

17. The heat exchanger of claim 16, wherein:
the header includes receptacle openings for receiving corresponding tube ends; at least one of the tube ends is tightly fit within the at least one opening of the mounting plate to limit the enclosed space; and
the at least one tube end is tightly fit within at least one opening of the header to limit the enclosed space such that an end portion of the at least one tube end does not extend within the tank portion of the header.

18. The heat exchanger of claim 14, wherein the mounting plate includes at least one channel defined on a surface facing the header to receive the bonding agent.

19. The heat exchanger of claim 18, wherein the channel extends substantially along the width of the mounting plate and is substantially parallel to at least one receptacle opening of the mounting plate receiving a corresponding tube end.

20. The heat exchanger of claim 18, wherein the channel extends around at least one receptacle opening of the mounting plate receiving a corresponding tube end.

21. The heat exchanger of claim 14, further comprising a venting opening in fluid communication with the enclosed space, the venting opening defined between the mounting plate and the surface of at least one tube end.

22. The heat exchanger of claim 21, wherein the venting opening is further defined by a groove extending from a receptacle opening of the mounting plate and the surface of the at least one tube end being receiving within the receptacle opening.

23. The heat exchanger of claim 14, wherein the header includes at least one injection opening in communication with the enclosed space, the injection aperture being operable to receive an injection needle to insert the bonding agent within the enclosed space.

24. The heat exchanger of claim 14, wherein the bonding agent substantially fills the enclosed space.

25. The heat exchanger of claim 14, wherein the bonding agent partially fills the enclosed space to form a void within the enclosed space.

26. The heat exchanger of claim 14, wherein the header comprises plastic.
